(19) United States
(12) Patent Application Publication
(10) Pub. No.: US 2009/0155386 A1
(43) Pub. Date: Jun. 18, 2009

(54) Method For Treating Agricultural Products Of Vegetable Origin and the Side-Products and/or Derivatives Obtained By Treatment

(76) Inventor: Xavier Van Den Avenne, Heusden (BE)

Correspondence Address: CLARK & ELBING LLP, 101 FEDERAL STREET, BOSTON, MA, 02110, US

(21) Appl. No.: 11/920,950

(22) PCT Filed: Aug. 3, 2005
(86) PCT No.: PCT/IB2005/002313

§ 371 Date: Jan. 29, 2008

(30) Foreign Application Priority Data
May 25, 2005 (BE) 2005/0256

(51) Int. Cl. A01N 59/08; A01P 1/00

(52) U.S. Cl. 424/680

(57) ABSTRACT

The present invention relates to a method to reduce the micro-biological load on agricultural raw materials, in which the agricultural raw materials are treated with an electrolysed saline solution, because of which the number of micro-organisms is reduced. With this method it will be possible to disinfect agricultural raw materials in a simple manner and at acceptable costs, without baleful consequences for the raw materials concerned.

The present invention relates to a method to reduce the micro-biological load on agricultural raw materials. In this patent application, by agricultural raw materials are meant: agricultural raw materials of vegetable origin and the side-products and/or derivatives obtained by treatment.

The side-products and/or derivatives are depending on the initial raw material. Examples of such side-products and/or derivatives are linseed shred (originating from linseed), soya shred (originating from soya beans), rape seed shred (originating from rape seed), short (originating from wheat), fodder maize (originating from maize), manioc pellets (originating from the manioc root), etc.

By nature, agricultural raw material is loaded with numerous microbic organisms. From the cultivation already, a microbiological load occurs in the form of bacteria, yeasts and fungi. Many of these organisms however, are not or less of a pathogenic nature, with respect to their ultimate destination (human food or animal fodder).

Some of these organisms are exceptions. Such as, for instance, the group of the enterobacteriaceae, to which the salmonella belongs, a potential danger to men and animals. Judging by the growing number of salmonella infections in food. Certain groups of fungi are potential sources of toxin producing organisms with very harmful consequences and toxicity with respect to human beings and animals.

The law provides for a ban on or a restriction of these organisms in order to reduce the risk whenever possible. As agricultural raw materials are constituting a possible risk of contamination in the various stages of cultivation, storing and processing, a suitable conservation and treatment impose themselves therefore.

In order to face this problem, various methods and products have already been developed in the past on the basis of thermal or chemical destruction or reduction. These known solutions however, are often laborious, too expensive and do not always result in the effect aimed at. Moreover, some of the known treatments have baleful consequences with respect. to the agricultural raw material to be treated, an example being the decrease/increase of the degree of acidity with possible modification as to the processibility/digestibility as a consequence.

The purpose of the invention is to provide a method which will enable agricultural raw materials to be treated in a simple manner and at an acceptable price, without having any baleful consequences with respect to the nature of the agricultural raw materials to be treated and to the environment.

The purpose of the invention is attained by providing a method to reduce the microbiological load on agricultural raw material, the agricultural raw materials being treated by means of an aqueous electrolysed saline solution, by which the number of micro-organisms can be reduced. With this method it becomes possible to disinfect agricultural raw materials in a simple manner and at acceptable expenses and to preserve them without baleful consequences for the agricultural raw materials concerned.

Although, up to now, agricultural raw materials were considered always to be kept dry during the various stages of their cultivation, among others when storing, in order to avoid fungoid growth and getting heated, it has quite unexpectedly appeared that by treating the said raw materials with an aqueous electrolysed saline solution, a distinct reduction of the micro-biological organisms present may be realized. Consequently, the risk of a further development of micro-biological organisms (among those, pathogenic germs) is strongly reduced.

An additional advantage is that the fluidity or the ‘free-flowing’ properties of the agricultural raw materials treated, by reducing the micro-biological load and therefore also the risk of developing mow-burn or heating up will be strongly reduced by reducing the micro-biological load and therefore also the risk of heating up or mow-burn. Indirectly, this will also have a positive influence on the possibilities for storing and transshipment of the material, more particularly, the period for its storage, for instance in a silo, may be longer, without danger for getting heated (because of increased micro-biological activities). Getting heated will cause the goods to get stuck and therefore they will become less ready for delivery and transshipment.

In a preferred method, the active chlorine content of the electrolysed saline solution is situated between 500 and 700 mg/l. Preferably, the pH-value of the electrolysed saline solution is situated between 7.2 and 8.5 and the redox potential of the electrolysed saline solution is situated between 700 and 900 mV. Furthermore, the said solution will contain about 0.2 to 0.5% salt (NaCl).

In a more preferred method according to the invention the electrolysed saline solution is atomized over the agricultural raw materials. Preferably, the quantity of electrolysed saline solution applied is situated between 0.2 and 2% of the quantity of raw material to be treated, particularly between 0.2 and 1.5%, more particularly between 0.2 and 0.5%.

The quantity of electrolysed saline solution applied is particularly depending on the kind of agricultural raw material to be treated, on the humidity typical of the agricultural raw material and the subsequent treating techniques. Therefore linseed shred (having a basic humidity of about 12%) is preferably treated with a quantity of electrolysed saline solution situated between 0.2 and 0.5%, in order to increase the total humidity after treatment to a maximum of 12.5%. 0.2% means an addition of 0.2% of the electrolysed saline solution, for instance: this is 2 litres for each 1000 kg (1 ton). With other applications to agricultural raw materials, having a lower humidity typical of the product, possibly larger quantities of electrolysed saline solution may be applied, however, depending on the final destination of the agricultural raw material (for instance, with respect to further treatment).

In another method, the said agricultural raw materials are briefly immersed in a electrolysed saline solution, because of which a maximum contacting surface is obtained between the raw materials and the electrolysed saline solution concerned. Preferably, the agricultural raw materials are briefly immersed, so that only the outer surface will enter in contact with the solution.

In a most preferred method, the said agricultural raw materials are chosen from agricultural products of vegetable origin and the side-products or derivatives obtained by treatment.

In order to further clarify the characteristics of the present invention and to point out its additional advantages and particulars, a more detailed description of the method applied will now follow. It may be obvious that nothing in the following description may be interpreted as a restriction of the protection of this invention demanded for in the claims.

In this description, by means of reference numbers, there will be referred to the drawings attached in which:

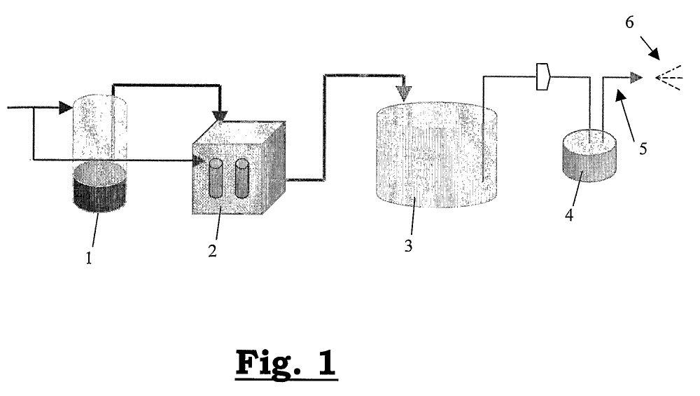

FIG. 1 shows a schematic representation of the installation for preparing the aqueous electrolysed saline solution.

Active chlorine kills bacteria by breaking down the chemical compounds and their molecules. Disinfectants that are used to that effect consist of chlorine components that are able to exchange atoms for other components, such as enzymes in bacteria and other cells. When enzymes will enter into contact with chlorine, one or several hydrogen atoms are replaced by chlorine. Therefore, the composition of the molecules will change and consequently the organism will decompose. When it is no longer possible for enzymes to function properly, the cell or the bacterium will finally die. An example of this process is the enzyme nitrate-reductase in the intercellular plasm of a bacterium cell.

In the method according to the invention, agricultural raw materials are treated by means of an aqueous electrolysed saline solution, by which a number of micro-organisms are reduced. To prepare the said saline solution and to treat the various raw materials, an installation (see FIG. 1) equipped with the following parts is provided:
a reservoir (1) for preparing a saturated saline (NaCl) solution, provided with automatic level control and water supply for dilution (for instance, tap water);
two stage filter installation to supply filtered tap water having a low degree of hardness;
a unit (2) to produce the electrolysed saline solution, this unit being equipped with a generator (50 A direct current);
a unit with flow-through electrolytic cells;
a diluting cell (venturi);
a reservoir (3) to receive and store the electrolysed and diluted saline solution;
a suction pump (4) (diaphragm type) for measuring out in doses the electrolysed and diluted saline solution (for instance, 50 bar max. output, flow rate 0-10 litre/minute);
a connecting hose (5) to distribute the electrolysed and diluted saline solution between the suction pump (4) and the spray/atomization/dosage device (6). The electrolysed solution is materialized by applying electrolysis to a saline solution (NaCl, technical degree of purity 99.7%). By submitting this saline solution to a process of electrolysis, a solution is produced having the following characteristics:
a content of active chlorine, situated between 500 and 700 mg/l;
a pH situated between 7.2 and 8.5;
a redux potential situated between 700 and 900 mV.

Depending on the acidity of the electrolysed solution a chemical balance is constituted. As represented in the diagram below, hypochlorous acid of about 90% is formed within the reach of the pH-value obtained.

Because, by nature, the cell wall of micro-organisms or bacteria has a negative electric charge, this cell wall can be penetrated by the neutral hypochlorous acid with the consequence that the cell functions as well as the cell division are disturbed.

Depending on the pH-value, hypochlorous acid (HOCl) will split up in hypochlorite ions:

HOCL+H₂O->H₃O⁺+Ocl⁼

This will finally disintegrate into chlorine and oxygen atoms:

Ocl⁼->Cl^{-+O}

Therefore, hypochlorous acid (HOCl when electrically neutral and hypochlorite ions (Ocl⁻, electrically negative) will form free chlorine, when they are put together. The result is a disinfecting action. The disinfecting properties of this solution consist of the disinfecting action of chlorine combined with the oxidizing properties of the free oxygen atoms.

The electrolysed saline solution obtained is applied to the agricultural materials through spraying or immersion. In case spraying is used, in addition, a solution of about 0.2-2%, preferably 0.2-0.5% is provided, depending on the application. The maximum quantity possible to be applied is determined by the final humidity of the agricultural material concerned.

After the electrolysed saline solution has been applied the agricultural materials treated will be removed for further processing or to be temporary stored, awaiting further treatment/handling.

The effectiveness of the method according to the invention is clearly shown in the following example. In this example the option was to apply the electrolysed saline solution to a side-product of rape seed rich in proteins.

On the basis of a series (n=10) of micro-biological analyses that were carried out, an average bacteriological profile of this raw material was made.

| | | |
|---|---|---|
| total bacterial count: | 200.000 | gfu/g |
| total of coliforms: | 10.000 | gfu/g |
| enterobacteriaciae: | 6.000 | gfu/g |
| fungi and yeasts: | 5.000 | gfu/u |

(gfu/g: germ forming unit per gram)

Applying the saline solution was done by means of spraying when unloading the goods from a ship and stored in a silo at the rate of 3 litre/min at a loading rate of about 100 tons/hour, ->average dose 0.3% on the basis of the product.

After treatment, each lot (n−10) was again subjected to a micro-biological analysis by means of a representative sampling. The following results were obtained:

| | | |
|---|---|---|
| total bacterial count: | 4.000 | gfu/g |
| total of coliforms: | 100 | gfu/g |
| enterobacteriaciae: | <10 | gfu/g |
| fungi and yeasts: | 500 | gfu/u |

Organoleptically, no deviations were found in the lots treated with respect to the lot not treated.

As appears from the example mentioned above, from the results obtained may be deducted that applying an electrolysed saline solution to agricultural raw materials will perform a clear reduction of the bacteria present, because of which the risk that pathogenic germs will occur will be significantly reduced.

1-8. (canceled)

9. A method to reduce the microbiological load on agricultural raw materials of vegetable origin or on side-products and/or derivatives thereof, comprising the step of spraying said agricultural raw materials or side-products and/or derivatives thereof with an aqueous electrolysed saline solution, wherein the dose of said solution is between 0.2 and 2% (v/w) of agricultural raw materials or side-products and/or derivatives.

10. The method according to claim 9, wherein the dose of said solution is between 0.2 and 0.5% (v/w) of agricultural raw materials or side-products and/or derivatives thereof.

11. The method according to claim 9, wherein the electrolysed saline solution has an active chlorine content between 500 and 700 mg/l.

12. The method according to claim 9, wherein the electrolysed saline solution has a pH between 7.2 and 8.5.

13. The method according to claim 9, wherein the electrolysed saline solution has a redox potential between 700 and 900 mV.

14. The method according to claim 9, wherein said electrolysed saline solution is atomized.

15. The method according to claim 9, wherein the side-products and/or derivatives of said agricultural raw materials of vegetable origin are selected from the group consisting of linseed shred, soy shred, rape seed shred, short from wheat, fodder maize and manioc pellets.
